(19) United States
(12) Patent Application Publication
(10) Pub. No.: US 2006/0006007 A1
(43) Pub. Date: Jan. 12, 2006

(54) System and method for providing electrical power to a vehicle

(76) Inventors: Steven Ernest, Windsor, CT (US); John J. Lester, West Hartford, CT (US); Hua Bai, Milpitas, CA (US)

Correspondence Address: COLLIER SHANNON SCOTT, PLLC, 3050 K STREET, NW, SUITE 400, WASHINGTON, DC, 20007, US

(21) Appl. No.: 11/175,252

(22) Filed: Jul. 7, 2005

Related U.S. Application Data
(60) Provisional application No. 60/585,642, filed on Jul. 7, 2004.

(51) Int. Cl. B60K 1/00

(52) U.S. Cl. 180/65.1

(57) ABSTRACT

The present invention is directed to a system for providing electrical power onboard a vehicle. In one embodiment, the system comprises: an AC/DC converter; an onboard power supply connected to the AC/DC converter so as to provide an input to the AC/DC converter; an external power source; a cable connected at one end to the external power source and at the other end to the AC/DC converter so as to provide electrical power from the external power source as an input to the AC/DC converter; and a controller, connected to the AC/DC converter and controlling various parameters of the selected power supply.

### CROSS-REFERENCE TO RELATED APPLICATION

This application claims priority on U.S. Provisional Patent Application Ser. No. 60/585,642, for System and Method for Providing Electrical Power to a Vehicle, filed on Jul. 7, 2004, the entirety of which is incorporated herein by reference.

### FIELD OF THE INVENTION

The present invention relates to a system and method for providing electrical power. In particular, the present invention is directed to a system and method for providing electrical power onboard a vehicle. Embodiments of the present invention may be used to power electronic devices onboard a heavy-duty truck.

### BACKGROUND OF THE INVENTION

Heavy-duty truck drivers are known to keep their trucks running at an idle while the trucks are not moving, for example, at rest stops. This is often done in order to provide power for the many electrical devices that may be found on-board the vehicle. If the truck is not running, available power is often drawn from the vehicle's battery, thereby depleting the battery.

In addition, the amount of electrical power available from the battery may not supply the truck with enough electricity to power all of the necessary or desired electrical components. Thus, to provide the necessary amount of electric power, truck drivers often run their trucks at an idle while at rest stops. This process, however, can lead to many drawbacks, including increased cost, unnecessary fuel consumption, increased pollution, and noise.

Many truck stops, in an effort to reduce the number of idling vehicles in light of the above detriments, may provide 120 volt or 240 volt power hook-ups for providing electrical power to the vehicles. In order to take advantage of these hook-ups, however, vehicles may require after-market inverters and/or chargers. These additional components can lead to increases in the cost of installation and use. In addition, many known after-market components generally have a continuous power output of only 1 kW. This amount of continuous power may not be enough to power all of the electrical components that are necessary and/or desired.

The systems and methods of the present invention may provide electrical power onboard a vehicle. Some, but not necessarily all, embodiments of the present invention may provide an inexpensive device to provide electrical power to a truck while at rest, in order to power necessary and desired electrical components without running the truck at idle. Some, but not necessarily all, embodiments of the present invention may provide a device that may enable heavy-duty trucks to take advantage of electrical hook-ups presently available at truck stops, by connecting their onboard electrical loads to such external power supplies. Some, but not necessarily all, embodiments of the present invention may provide a device that will provide a high enough continuous power output in order to power all necessary and desired electrical components. Some, but not necessarily all, embodiments of the present invention may be installed on a heavy-duty truck during its production for only a small increase in cost.

Additional advantages of embodiments of the invention are set forth, in part, in the description which follows and, in part, will be apparent to one of ordinary skill in the art from the description and/or from the practice of the invention.

### SUMMARY OF THE INVENTION

Applicant has developed innovative systems and methods for providing electrical power onboard a vehicle. In one embodiment, the system comprises: an AC/DC converter; a power supply connected to the AC/DC converter so as to provide an input to the AC/DC converter; a cable connected at one end to the power supply and at the other end to the AC/DC converter so as to provide an electrical power from the external power source as an input to the AC/DC converter; and a controller, connected to the AC/DC converter and controlling various parameters of the selected power supply.

Applicant has further developed a system for providing electrical power onboard a vehicle, the system comprising: an AC/DC converter; an onboard power supply connected to the AC/DC converter so as to provide an input to the AC/DC converter; an external power source; a cable connected at one end to the external power source and at the other end to the AC/DC converter so as to provide electrical power from the external power source as an input to the AC/DC converter; at least one AC load; a DC/AC converter, connected so as to receive inputs from the AC/DC converter, convert the electrical power to a desired phase and magnitude, and send outputs to the AC load; at least one DC load; a DC/DC converter, connected so as to receive inputs from the AC/DC converter, convert the electrical power to a desired phase and magnitude, and send outputs to the DC load; and a controller, connected to the AC/DC converter and controlling various parameters of the selected power supply.

It is to be understood that both the foregoing general description and the following detailed description are exemplary and explanatory only, and are not restrictive of the invention as claimed. The accompanying drawings, which are incorporated herein by reference, and which constitute a part of the specification, illustrate certain embodiments of the present invention and, together with the detailed description, serve to explain the basic principles of the present invention.

### BRIEF DESCRIPTION OF THE DRAWINGS

In order to assist in the understanding of the present invention, reference will be made to the appended drawings, in which like reference characters refer to like elements. The drawings are exemplary only, and should not be construed as limiting the invention.

FIG. 1 is a block diagram of a starter/alternator power supply system in accordance with a first embodiment of the present invention.

FIG. 2 is a block diagram of a starter/alternator power supply system in accordance with a second embodiment of the present invention.

FIG. 3 is a block diagram of a starter/alternator power supply system in accordance with a third embodiment of the present invention.

### DETAILED DESCRIPTION OF EMBODIMENTS OF THE INVENTION

Reference will now be made in detail to embodiments of the system and method of the present invention, examples of which are illustrated in the accompanying drawings. As embodied herein, the present invention comprises systems and methods of providing electrical power to one or more systems and loads onboard a vehicle.

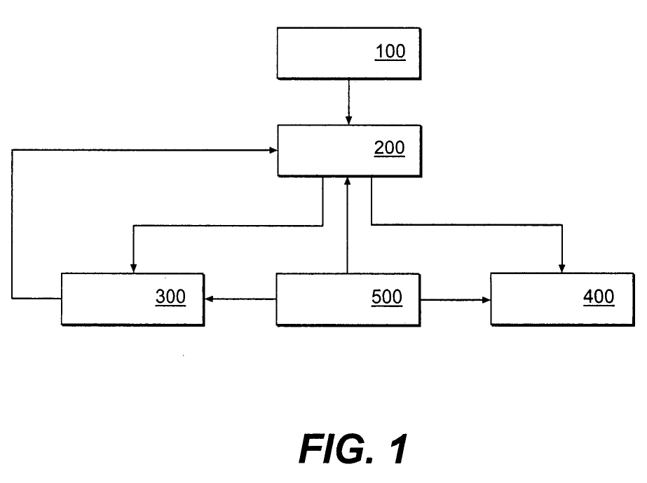

FIG. 1 illustrates a first embodiment of a system 10 for providing electrical power to one or more loads onboard a vehicle. The system 10 may comprise a power system 100, an alternating current/direct current (AC/DC) converter 200, an AC power supply system 300, a DC power supply system 400, and a controller 500.

The power system 100 may provide an electrical input to the overall system. The power system 100 may comprise an on-board power supply, including but not limited to, an alternator, a starter/alternator, a battery, a generator, a fuel cell, and/or an exterior power supply to which the operator may have access.

The AC/DC converter 200 may be electrically connected to the power system 100 and may convert, if necessary, the electrical input from alternating current (AC) to direct current (DC). The AC/DC converter 200 may also convert the incoming current to a specified voltage rating. The AC/DC converter 200 may then output the DC electrical supply to the AC power supply system 300 and the DC power supply system 400.

The AC power supply system 300 may be electrically connected to the AC/DC converter 200. The AC power supply system 300 may receive DC from the AC/DC converter 200. The AC power supply system may modify the incoming DC to the proper form, phase, and voltage rating for components that require an AC input.

The DC power supply system 400 may also be electrically connected to the AC/DC converter 200. The DC power supply system 400 may receive a DC input from the AC/DC converter 200, and it may modify the incoming DC to the proper or desired voltage rating appropriate for its components. The DC power supply system 400 may also provide the proper DC inputs to onboard DC components.

The controller 500 may be electrically connected to the AC/DC converter 200, the AC power supply system 300, and the DC power supply system 400. The controller 500 may control the input of the power system 100 into the AC/DC converter 200, the output of the AC/DC converter 200, and the requirements of both the AC power supply system 300 and the DC power supply system 400.

With continued reference to FIG. 1, the system in accordance with the first embodiment of the present invention may generally operate as follows. The power system 100 may input electrical power into the AC/DC converter 200. The power system 100 may receive power from either an onboard system, such as, but not limited to a starter/alternator, or an external power source, such as, but not limited to a power hook-up at a truck stop. The AC/DC converter 200 may convert the power received from the power system 100 from alternating current to direct current. The voltage magnitude and rating of the output of the AC/DC converter 200 may be monitored and controlled by controller 500. The AC/DC converter 200 may then output the DC to both the AC power supply system 300 and the DC power supply system 400.

The AC power supply system 300 may receive the electrical input from the AC/DC converter 200. The amount of power needed for the AC power supply system 300 may be determined by the controller 500. Any excess power from the AC power supply system 300 may be returned to the AC/DC converter 200. The AC power supply system 300 may modify the incoming DC to the proper phase, magnitude and voltage rating required by the AC power supply system 300 components.

The DC power supply system 400 may also receive an electrical input from the AC/DC converter 200. The amount of power needed for the DC power supply system 400 may be determined by the controller 500. The DC power supply system 400 may modify the magnitude and/or the voltage level of the incoming DC from the AC/DC converter 200 as required by the DC power supply system 400. The DC power supply system 400 may then supply the necessary amounts of power to the DC components.

The controller 500 may control the input of the power system 100 into the AC/DC converter 200, the output of the AC/DC converter 200, and the requirements of both the AC power supply system 300 and the DC power supply system 400. One method of monitoring the requirements of the AC power supply system 300 and the DC power supply system 400 is to monitor the required and/or desired loads of each respective system. The loads of each system may vary according to which and how many components are operated.

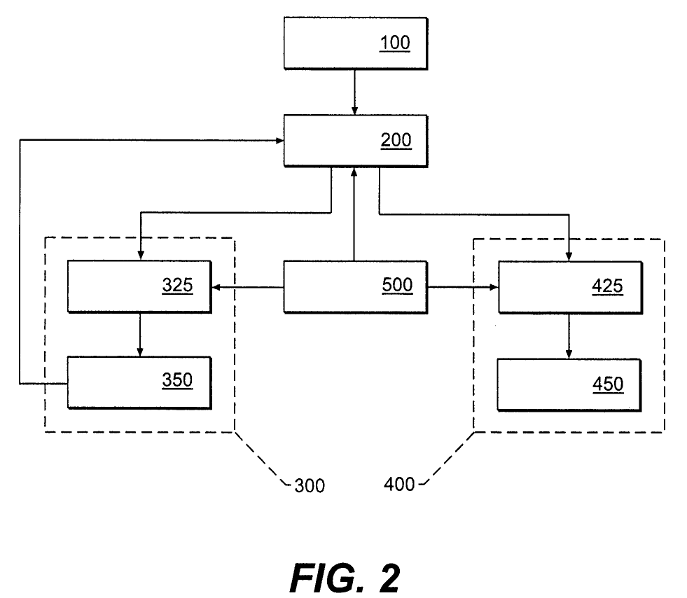

FIG. 2 illustrates a second embodiment of the present invention. The system 10 may comprise a power system 100, an alternating current/direct current (AC/DC) converter 200, an AC power supply system 300, a DC power supply system 400, and a controller 500. In the second embodiment, the AC power supply system 300 may further comprise a DC/AC converter 325 and at least one AC load 350. The DC power supply system may further comprise a DC/DC converter 425 and at least one DC load 450.

The power system 100 may input electrical power, in either multi-phase AC current or single phase AC current, to the AD/DC converter 200. The AC/DC converter 200 is controlled by the controller 500. The controller 500 synchronizes the inputs of the AC/DC converter 200 so that the multi-phase AC input and single phase AC input are not provided as inputs into the AC/DC converter 200 simultaneously.

The output of the AC/DC converter 200 may then be provided as an input to the DC/AC converter 325 and the DC/DC converter 425. The DC/AC converter 325 may convert the DC back into AC, while also modifying the current to be of the proper magnitude and voltage rating for the AC loads 350. The DC/AC converter 325 may be monitored and controlled by the controller 500. The DC/AC converter 325 may then output the AC to the AC loads 350.

The DC/DC converter 425 may modify the electrical power provided as an input from the AC/DC converter 200 in order to supply an input of the proper magnitude and voltage rating to the DC loads 450. The DC/DC converter 425 may be monitored and controlled by the controller 500. The DC/DC converter 425 may then output the DC to the DC loads 450.

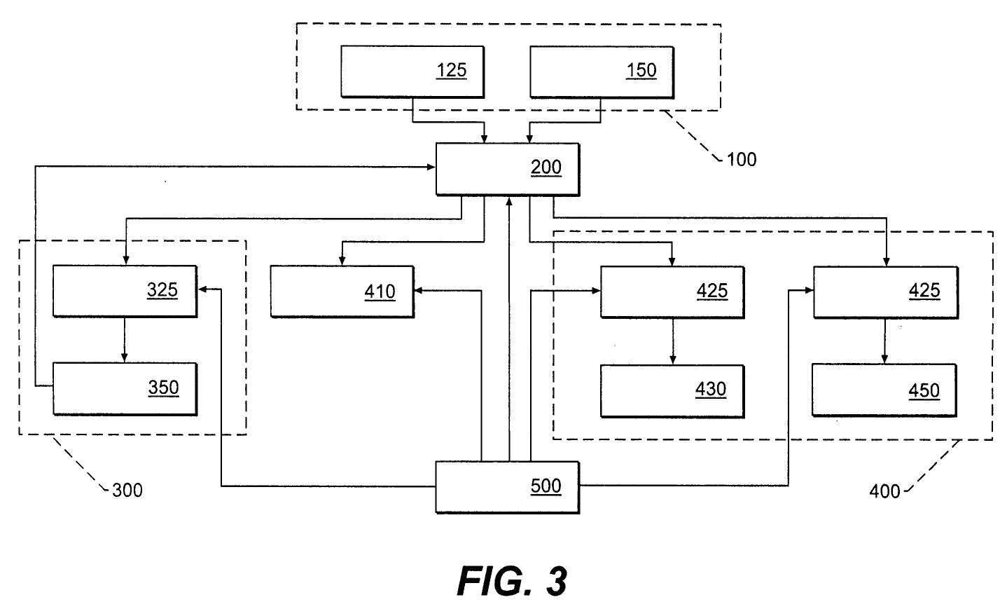

With reference to FIG. 3, in which like reference characters refer to like elements, a third embodiment of the present invention will now be described. The power system 100 may further comprise an external power source 125 and/or an internal power source 150, such as, but not limited to, a starter/alternator.

The AC power supply system 300 may include a DC/AC converter 325 and AC loads 350. The AC loads 350 may be any electrical device powered by the onboard power system.

The DC power supply system 400 may include one or more DC/DC converters 425 and DC loads 450. In addition, one DC load may comprise an eddy current retarder 430.

When a truck is moving, the starter/alternator 150 may work as an alternator, producing an AC output. This AC output of the starter/alternator 150 is provided as an input to the AC/DC converter 200, which converts the AC to DC. The output of the AC/DC converter 200 may match the requirements of the battery 410 and/or of other onboard DC loads. If the AC/DC converter's output 200 does not match the requirements of any DC load, the DC required for that specific load may be provided as an input to a DC/DC converter 425, which may in turn provide power of the appropriate requirements. If a heavy-duty truck is equipped with any onboard AC loads, the output of the AC/DC converter 200 may be provided as an input to the DC/AC converter 325. The DC/AC converter 325 may convert the power to the appropriate magnitude and/or frequency required by the AC loads. The magnitude and/or the frequency of the outputs of the AC/DC converter 200, the DC/DC converter 425, and/or the DC/AC converter 325 may be controlled by the controller 500.

When the truck is not moving, for example at a truck stop, the engine may be shut down, and thus the alternator may not be running. If the truck stop is equipped with external power sources 125 (i.e., electrical outlets provided as power hook-ups), the AC/DC converter 200 may be directly attached to the power hook-up with a cable in order to provide electrical power to the onboard systems. The controller 500 may control the external power source 125 in order to prevent electrical power from the starter/alternator 150 and the external power source 125 from being provided to the AC/DC converter 200 simultaneously. Additionally, the controller 500 may generate a control signal for the AC/DC converter 200 when it is connected to the external power supply 125. The control signal may be necessary if the AC/DC converter 200 is a multi-phase converter and the electrical power provided by the external power supply 125 is single phase. Now, instead of drawing electrical power from the starter/alternator 150, power may be drawn from the power hook-up. The AC/DC converter 200 may be of a sufficiently high power rating to provide all of the electrical power needs of the onboard systems through the external power source 125, and without the need for the truck to idle.

It will be apparent to those skilled in the art that various modifications and variations can be made in the construction, configuration, and/or operation of the present invention without departing from the scope or spirit of the invention.

What is claimed is:

1. A system for providing electrical power onboard a vehicle, the system comprising:
an AC/DC converter;
a power supply connected to the AC/DC converter so as to provide an input to the AC/DC converter;
a cable connected at one end to the power supply and at the other end to the AC/DC converter so as to provide electrical power from the power supply as an input to the AC/DC converter; and
a controller, connected to the AC/DC converter and controlling at least one parameter of the selected power supply.

2. The system of claim 1, wherein the power supply comprises an on board power supply.

3. The system of claim 2, wherein the onboard power supply comprises an onboard power supply selected from the group consisting of: an alternator, a starter/alternator, a battery, a generator, and a fuel cell.

4. The system of claim 1, wherein the power supply comprises an external power source.

5. The system of claim 4, wherein the external power source comprises a power hook-up at a truck stop.

6. The system of claim 1, wherein the power source comprises:
an onboard power supply; and
an external power source.

7. The system of claim 6, wherein the cable is connected at one end to the external power source.

8. A system for providing electrical power onboard a vehicle, the system comprising:
an AC/DC converter;
an onboard power supply connected to the AC/DC converter so as to provide an input to the AC/DC converter;
an external power source;
a cable connected at one end to the external power source and at the other end to the AC/DC converter so as to provide electrical power from the external power source as an input to the AC/DC converter;
at least one AC load;
a DC/AC converter, connected so as to receive inputs from the AC/DC converter, convert the electrical power to a desired phase and magnitude, and send outputs to the AC load;
at least one DC load;
a DC/DC converter, connected so as to receive inputs from the AC/DC converter, convert the electrical power to a desired phase and magnitude, and send outputs to the DC load; and
a controller, connected to the AC/DC converter and controlling various parameters of the selected power supply.

9. The system of claim 8, further comprising an eddy current retarder, connected so as to receive as an input electrical power from the DC/DC converter.

10. The system of claim 8, further comprising an eddy current retarder, connected so as to receive as an input electrical power from the DC/AC converter.
